(19) United States
(12) Patent Application Publication
(10) Pub. No.: US 2009/0302996 A1
(43) Pub. Date: Dec. 10, 2009

(54) SYSTEM AND METHOD FOR A MANAGEMENT SERVER

(75) Inventors: Sokwoo Rhee, Lexington, MA (US); Sheng Liu, Cambridge, MA (US); Sean J. Lantry, Londonderry, NH (US); Mark D. O'Hearne, Newton, MA (US); Martin Hanssmann, Portsmouth, NH (US)

Correspondence Address: FOLEY & LARDNER LLP, 111 HUNTINGTON AVENUE, 26TH FLOOR, BOSTON, MA, 02199-7610, US

(73) Assignee: MILLENNIAL NET, INC.

(21) Appl. No.: 12/136,614

(22) Filed: Jun. 10, 2008

(51) Int. Cl. G05B 23/02

(52) U.S. Cl. 340/3.32

(57) ABSTRACT

The energy management system and/or method includes at least one wireless controller in a wireless network and/or a management server. The wireless controller manages at least one energy device based on one or more parts of an energy profile. The management server manages one or more parts of the energy profile, transmits one or more parts of the energy profile to the wireless controller, and receives energy data from the wireless controller.

### BACKGROUND

Energy management saves financial and environmental resources by monitoring and controlling energy consumption to better align it with operational needs and policies, and thereby reduce wasteful energy consumption, associated emissions, and expense. With increasing costs of energy, decreasing availability of non-renewable energy sources, and worsening global pollution and environmental problems, there is need for effective energy management.

Energy management systems typically include controllers that directly manage energy devices. Historically, energy management systems concentrate management intelligence either individually in the controllers or collectively in a centralized hub that directly controls the controllers. These energy management systems do not allow for the efficient use of the different elements.

### SUMMARY OF THE INVENTION

One approach to energy management is an energy management system. The energy management system includes at least one wireless controller and a management server. The wireless controller is in a wireless network and manages at one or more energy devices based on one or more parts of an energy profile. The management server receives energy data from the wireless controller, manages the one or more parts of the energy profile based on the energy data, and transmits the one or more parts of the energy profile to the wireless controller.

Another approach of the energy management system includes a means for managing at least one energy device based on one or more parts of an energy profile. The energy management system further includes a means for receiving energy data from the wireless controller and a means for managing the one or more parts of the energy profile based on the energy data. The energy management system further includes a means for transmitting the one or more parts of the energy profile to the wireless controller.

An additional approach to energy management includes a method for energy management. The method includes receiving, by a management server, energy data from at least one wireless controller in a wireless network. The method further includes modifying, by the management server, one or more parts of the energy profile based on the energy data and transmitting, by the management server, one or more parts of modified energy profile to the wireless controller. The method further includes managing, by the wireless controller, one or more energy devices based on the one or more parts of the modified energy profile.

Another approach to energy management is a management server. The management server includes a communication module, an analysis module, and a profile module. The communication modules receives energy data from one or more wireless controllers and one or more energy devices associated with the wireless controllers. The analysis module analyzes the energy data to create modifications for one or more parts of an energy profile. The profile module manages the one or more parts of the energy profile and modifying the one or more parts of the energy profile based on the modifications. The communication module transmits the modified one or more parts of the energy profile to the wireless controllers.

An additional approach to energy management is a management server. The management server includes a means for receiving energy data from one or more wireless controllers and one or more energy devices associated with the wireless controllers and a means for analyzing the energy data to create modifications for one or more parts of an energy profile. The management server further includes a means for managing the one or more parts of the energy profile and a means for modifying the one or more parts of the energy profile based on the modifications. The communication module transmits the modified one or more parts of the energy profile to the wireless controllers.

Another approach to energy management is a method for energy management. The method includes receiving energy data from one or more wireless controllers and one or more energy devices associated with the wireless controllers and analyzing the energy data to create modifications for one or more parts of an energy profile. The method further includes modifying the one or more parts of the energy profile based on the modifications and transmitting the modified one or more parts of the energy profile to the wireless controllers.

An additional approach to energy management is a wireless controller. The wireless controller includes a control module and a network interface module. The control module manages at least one energy device based on one or more parts of an energy profile. The network interface module transmits energy data to a management server and receives the one or more parts of the energy profile from the management server.

Another approach to energy management is a wireless controller. The wireless controller includes a means for managing at least one energy device based on one or more parts of an energy profile and a means for transmitting energy data to a management server. The wireless controller further includes a means for receiving the one or more parts of the energy profile from the management server.

An additional approach to energy management is a method for energy management. The method includes monitoring at least one energy device based on one or more parts of an energy profile and transmitting energy data to a management server. The method further includes receiving the one or more parts of the energy profile from the management server.

In other examples, any of the approaches above can include one or more of the following features. The energy device includes at least one of an energy-consuming device or an energy-producing device. The wireless network includes a wireless mesh network. The wireless controller self-configures the wireless mesh network to forward and/or route communication between the wireless controller and the management server.

In some examples, the system includes a wireless repeater for extending a range of the wireless mesh network. The system includes one or more wireless sensors to collect the energy data or parts thereof and transmit the energy data or parts thereof via the wireless network to the wireless controller.

In other examples, the system includes a wireless sensor to monitor the energy device. The wireless sensor is managed by the wireless controller. The wireless sensor monitors the electrical current and power of the energy device. The wireless sensor measures a temperature, an environmental level of carbon dioxide, an environmental level of carbon monoxide, and/or a pressure.

In some examples, a wireless gateway communicates between the wireless network and the management server. The management of the energy device includes controlling, directing, and/or monitoring the energy device. The energy data includes energy consumption data, environmental data, and/or energy generation data. The wireless network includes a wireless mesh network. The wireless mesh network is self-configured to forward and/or route communication between the wireless controller and the management server.

In other examples, one or more wireless sensors collect the energy data or parts thereof and transmits the energy data or parts thereof via the wireless network to the wireless controller. A wireless sensor monitors the energy device. The wireless controller manages the wireless sensor.

In some examples, the system further includes a client module for remote management of the management server. The system further includes a storage module for storing the energy data, the modifications for one or more parts of the energy profile, the one or more parts of the energy profile, or any combination thereof.

In other examples, the analysis module further creates a report based on the energy data. The analysis module further determines an alert based on the energy data. The energy profile includes one or more operational modes. The energy profile includes a schedule specifying the operational mode utilized in a given timeframe. The schedule includes a hierarchy of one or more sub-schedules. The schedule includes at least one of a default schedule, a vacation schedule, or a special event schedule.

In some examples, the system includes a client module for remotely managing the management server. The system further includes a storage module for storing the energy data, the modifications for one or more parts of the energy profile, and/or the one or more parts of the energy profile.

In other examples, the analysis module creates a report based on the energy data. The analysis module determines an alert based on the energy data.

In some examples, the network interface module routes and/or forwards communications via a wireless mesh network. The control module manages the energy device based on second energy data collected by one or more wireless sensors. The wireless controller further includes one or more wireless actuators for actuating and/or deactuating the energy devices. The wireless controller further includes a display device for visual communication, audio communication, and/or tactile communication.

In some examples, the wireless controller operates autonomously based on the one or more parts of the energy profile. The control module allows for manual user control of the wireless controller. The control module stores the one or more parts of the energy profile. The wireless controller routes and/or forwards communications via a wireless mesh network.

In other examples, the energy device is managed based on second energy data collected by one or more wireless sensors. The energy devices are actuated and/or deactuated by one or more wireless actuators. The wireless controller operates autonomously based on the one or more parts of the energy profile. The wireless controller stores the one or more parts of the energy profile.

In some examples, an alert is determined based on the one or more parts of the energy profile and/or the energy data. The energy device is managed based on the one or more parts of the energy profile and/or the energy data. The managing of the energy device includes controlling, directing, and/or monitoring the energy device.

The energy management techniques described herein can provide one or more of the following advantages. An advantage to that the energy management system is that the distribution of the management intelligence of the energy devices enables a cost-effective solution to energy management. Another advantage to the energy management system is that the wireless mesh network enables wireless controllers to be installed and put into service with minimal cost and disruption to existing facilities and operations (i.e., easy to retrofit into existing energy infrastructure). An additional advantage to the energy management system is that the deployment of wireless controllers and sensors enables the monitoring and analysis of energy devices which enables consumers to maximize the energy investment. Another advantage to the energy management system is that the wireless controllers and sensors can be rapidly established and operate in an extensive and universal multi-site management system across global sites by coupling the ease, minimal costs, and non-invasive nature of installation at each site with widely available communications infrastructure such as telecommunications and the internet.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A depicts an overview of an exemplary energy management system;

FIG. 1B depicts an overview of another exemplary energy management system;

FIG. 2 is a diagram of an exemplary management server on a network;

FIG. 3 is a diagram of an exemplary wireless gateway, a wireless mesh network, and a network;

FIG. 4 is a diagram of an exemplary wireless controller managing energy devices and sensors;

FIG. 5 is a diagram of an exemplary wireless controller providing thermostat functions;

FIGS. 6A and 6B illustrate two examples of an energy profile;

FIG. 7 is a flowchart illustrating management of wireless controllers by a management server utilizing an energy profile and energy data;

FIG. 8 is a flowchart illustrating monitoring of wireless controllers and associated energy devices by a management server; and

FIG. 9 is a flowchart illustrating management of energy devices by a wireless controller utilizing an energy profile and sensor data.

### DETAILED DESCRIPTION OF THE PREFERRED EMBODIMENTS

Generally, the system and method for energy management is reducing the overall energy costs related to energy devices (e.g., air conditioners, lights, fans, etc.). The management of the energy devices can provide a cost-effective solution to energy management by maximizing the effective use of energy-producing devices (e.g., generators, windmills, solar panels, etc.) and minimizing energy use of energy-consuming devices (e.g., air conditioners, heaters, lights, etc.). The management of the energy devices can be performed jointly and independently by a management server and wireless controllers.

The management server and the wireless controllers jointly manage an energy profile (e.g., activate the lights at 8:00 am and turn off the lights at 5:00 pm, use solar power from 8:00 am to 12:00 pm, etc.) for the energy devices. The joint management of the energy profile can advantageously provide centralized management of the energy profile while still allowing individualized management of certain features (e.g., temperature ranges, temperature overrides, etc.). The wireless controllers can independently manage the energy devices based on the energy profile which advantageously allows the wireless controllers to operate based on the energy profile without interaction from the management server.

Additionally wireless controllers can be added to the energy management system with minimal effort and cost since the additionally wireless controllers can operate based on the established energy profile received from existing energy devices. For example, the management server manages an energy profile of an office complex. The wireless controllers for the lights in each office are added in the office complex as funding and time permits. As each wireless controller is added, the wireless controller manages the associated light based on the previously established energy profile (e.g., activate the lights at 8:00 am and turn off the lights at 6:00 pm). As such, the addition of the wireless controllers does not require significant administration time, but only requires the installation and wireless setup of the wireless controller.

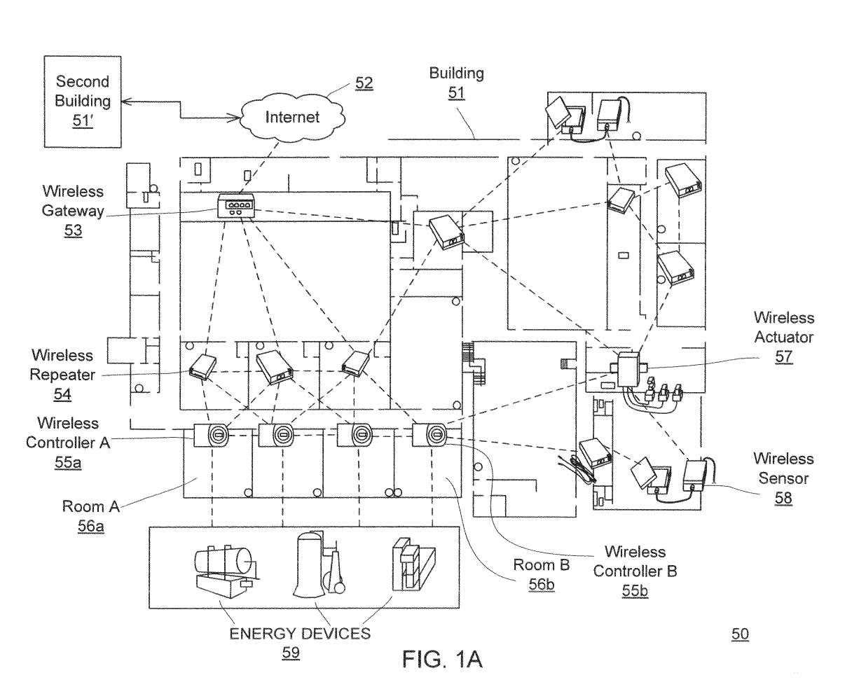

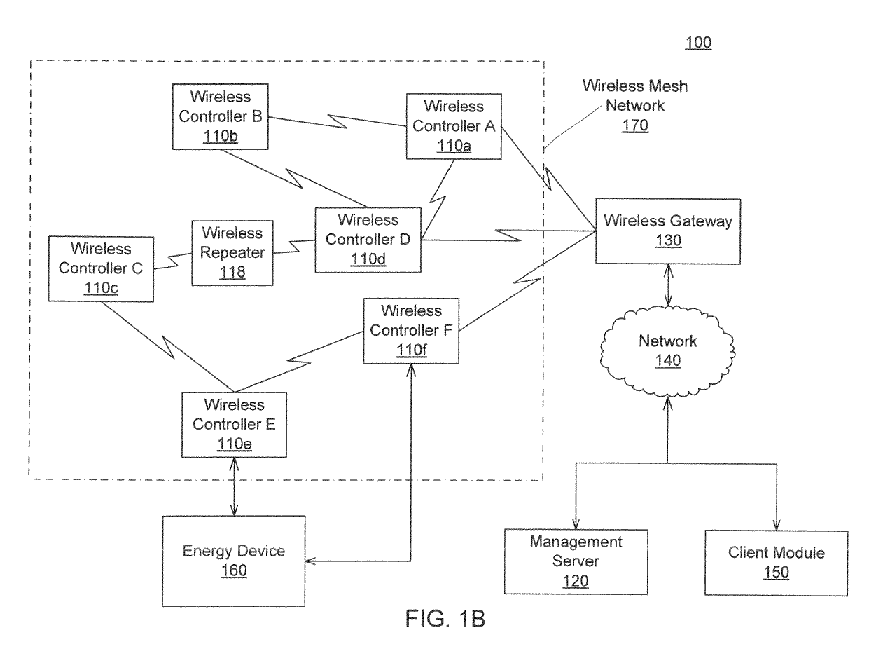

Referring to FIG. 1A, an energy management system 50 is depicted. The energy management system 50 is associated with a building 51 or a series of buildings (e.g., a second building 51′, an office complex, a school campus, global offices, commonly-owned buildings, commonly-managed buildings, etc.). The energy management system 50 includes the internet 52, a wireless gateway 53, a wireless repeater 54, a wireless controller A 55a, a wireless controller B 55b, a wireless actuator 57, a wireless sensor 58, and energy devices 59. The building 51 includes a plurality of rooms (e.g., room A 56a and room B 56b). The energy management system 50 is interconnected via a wireless mesh network. The wireless gateway 53 connects the wireless mesh network with a management server (not shown) via the internet 52. The wireless repeater 54 extends the range of the wireless mesh network by forwarding and/or routing communications between the wireless controllers 55a and 55b, the wireless sensor 58 and/or the wireless actuator 57. The wireless controllers A 55a and B 55b are associated with the rooms A 56a and B 56b, respectfully. The wireless actuator 57 actuates and/or deactuates energy devices and/or any other type of device (e.g., mechanical device, electrical device, etc.). The wireless sensor 58 provide energy data to the wireless controllers A 55a and B 55b and/or the management server.

Each wireless controller A 55a and B 55b manages the energy devices 59 associated with the respective room based on an energy profile and/or energy data (e.g., environmental data, energy consumption data, energy generation data, etc.). For example, the wireless controller A 55a directs the heating unit (i.e., one of the energy devices 59) to activate and heat the room A 56a. As part of the heating of the room A 56a, the wireless controller A 55a directs the wireless actuator 57 to actuate a baffle and a fan to force a limited amount of outside air into room A 55a.

In some embodiments, the wireless controllers A 55a and B 55b can communicate with each other via the wireless mesh network. For example, the wireless sensor 58 transmits temperature data to the wireless controller A 55a via wireless controller B 55b and the wireless mesh network. In other words, the wireless sensor 58 transmits the temperature data to the wireless controller A 55a via the wireless mesh network through the following devices: the wireless sensor 58, a first wireless repeater, wireless controller B 55b, a second wireless repeater, a third wireless repeater, and then the wireless controller A 55a.

In other embodiments, the wireless sensor 58 communicates with other safety and/or medical devices within and/or near the building. The other safety and/or medical devices can include a medical alert device, a security alert device, a communication device, and/or any other type of device associated with safety and/or medical needs of a building. For example, the wireless sensor 58 receives medical alerts from a medial alert device within and/or near the building 51. The wireless sensor 58 communicates the alert data to the management server and/or a wireless controller. The management server and/or the wireless controller 55 processes the alert data and notifies the appropriate personal (e.g., police, fire, etc.). In some embodiments, the management server and/or the wireless controller 55 can communicate with the safety and/or medical device to notify the user regarding updated information (e.g., police are two minutes away, ambulance is in the building 51, etc.).

Although FIG. 1A illustrates the wireless controllers 55 associated with a room 56, the wireless controllers 55 can be associated with individual energy devices 59 and/or groups of energy devices 59. For example, room A 56a is a kitchen and includes a first wireless controller (not shown) associated with an oven (not shown), a second wireless controller (not shown) associated with a refrigerator (not shown), a third wireless controller (not shown) associated with lights in the kitchen, and the wireless controller A 55a associated with the heating unit. In other words, each room 56 can include a plurality of wireless controllers 55.

Referring to FIG. 1B, an energy management system 100 includes wireless controllers 110a, 110b, 110c, 110d, 110e, . . . 110n (generally 110) in a wireless mesh network 170. The energy management system 100 further includes a wireless repeater 118, a management server 120, a wireless gateway 130, a network 140, and a client module 150. In one embodiment, the wireless controller 110e manages (e.g., controls, directs, monitors, etc.) an energy device 160 (e.g., heater, air conditioner, lights, windmill, etc.). The wireless repeater 118 forwards and/or routes communications between wireless controller D 110d and wireless controller C 110c via the wireless mesh network thereby extending the range of the wireless mesh network 170. The wireless gateway 130 connects the wireless mesh network 170 to the management server 120 via the network 140. The management server 120 communicates with the wireless controllers 110 via the network 140 (e.g., the internet) and the wireless gateway 130 and transmits part or all of an energy profile to one or more of the wireless controllers 110. The management server 120 also receives energy data from the wireless controllers 110. The client module 150 includes an interface utilized to manage the management server 120 directly or remotely via the network 140.

The energy management system 100 can be, for example, utilized in a building and/or a group of buildings (e.g., campus, office complex, global office complex, city-wide campus, etc.). The energy management system 100 can be utilized in a retail store, an office, an educational facility (e.g., elementary school, school district, university, etc.), a healthcare facility (e.g., doctor's office, hospital, nursing home, etc.), a lodging facility (e.g., hotel, motel, etc.), a warehouse, a food service facility, an assembly facility, and/or any other type of building.

Each wireless controller 110 manages at least one energy device based on one or more parts of an energy profile. An advantage to the management of energy devices by the wireless controller 110 is that each individual wireless controller 110 can implement and enforce the appropriate energy management policy that can effectively manage energy consumption. In one embodiment, the wireless controller E 110e manages the energy device 160. The wireless controller E 110e can, for example, manage the energy device 160 directly by utilizing a wired connection (e.g., serial connection, ethernet connection, fiber optic connection, etc.) and/or wireless connection (e.g., wireless personal area network, cellular phone network, etc.) between the energy device 160 and the wireless controller E 110e. The wireless controller E 110e can, for example, monitor the energy device 160 indirectly by utilizing one or more sensors (not shown).

The wireless controller E 110e communicates the monitored energy data to the management server 120 via the wireless mesh network 170 and the network 140. The management server 120 manages one or more parts of an energy profile based on the energy data, preferences, and/or other information associated with the energy management system 100 (e.g., building holidays, occupancy vacation, weather, power demands, etc.). The energy profile is utilized to distribute the intelligence of the energy management system 100 across the wireless controllers 110 and the management server 120. For example, each wireless controller 110 can independently and autonomously manage the energy device 160 based on the energy profile or parts thereof and/or the energy data. An advantage of distributing the intelligence allows for easy deployment and adoption of the energy management system 100 since both the wireless controller 110 and the management server 120 manage the energy policy compliance and optimization.

The management server 120 transmits part or all of the energy profile to each wireless controller 110. In some examples, the management server 120 transmits all of the energy profile to each wireless controller 110 to enable backups and/or redundancy between the wireless controller 110a, 110b, 110c, 110d, 110e, . . . , 110n. The storage of all of the energy profile by each wireless controller 110 enables the wireless controllers 110 to provide backups of the energy profile to the management server 120 and/or to other wireless controllers 110 not currently in communication on the wireless mesh network 170. One advantage to storing the profile on each wireless controller 110 is that each wireless controller 110 can independently operate using the energy profile whether or not the wireless controller 110 in communication with the management server 120.

All of the energy profile can be, for example, transmitted to each wireless controller 110 to enable the wireless controllers 110 to provide backup management to the energy devices. For example, wireless controller F 110f is designed as the backup controller for the energy device 160. When wireless controller E 110e is not available as the primary controller for the energy device 160, then wireless controller F 110f acts as the primary controller for energy device 160 (e.g., via a wireless connection between the wireless controller F 110f and the energy device 160) when the wireless controller F 110f is within wireless range to the energy device 160.

The wireless controller E 110e manages the energy device 160 by utilizing at least one part of an energy profile associated with the energy device 160. For example, the wireless controller E 110e manages the energy device 160 (in this example, lights in an office complex). The wireless controller E 110e includes a part of the energy profile regarding the lights for the office complex (i.e., office lighting energy profile) is illustrated in Table 1.

TABLE 1
Exemplary Office Lighting Energy Profile.

| Mode | Start Time | End Time | Days | Lights | Time Delay |
|---|---|---|---|---|---|
| Occupied | 8:00 am | 5:00 pm | Weekdays | On | |
| Unoccupied | 5:01 pm | 7:59 am | Weekdays | Motion | 5 minutes |
| Unoccupied | | | Weekends | Off | |

The wireless controller E 110e manages the lights (i.e., the energy device 160) based on the office lighting energy profile stored by the wireless controller E 110e and actuates and deactuates the lights according to the office lighting energy profile.

As a further example, the wireless controller C 110c manages heating, ventilating, and air conditioning (HVAC) for the office complex. The wireless controller C 110c can manage the HVAC units for the office complex utilizing a wired connection, a wireless connection, and/or a pneumatic controlled connection. The wireless controller C 110c includes a different part of the energy profile for the office complex (i.e., office HVAC energy profile). The office HVAC energy profile includes information as illustrated in Table 2.

TABLE 2
Exemplary Office HVAC Energy Profile.

| Mode | Start Time | End Time | Days | Temperature | Range |
|---|---|---|---|---|---|
| Ramp-Up | 7:00 am | 7:59 am | Weekdays | 70 | ±3 |
| Occupied | 8:00 am | 5:00 pm | Weekdays | 73 | ±3 |
| Unoccupied | 5:01 pm | 6:59 am | Weekdays | 65 | ±3 |
| Unoccupied | | | Weekend | 65 | ±3 |

The wireless controller C 110c manages the heating, ventilating, and air conditioning units for the office complex based on the office HVAC energy profile (i.e., part of the energy profile for the office complex). In these examples, Tables 1 and 2 are parts of an energy profile for the office complex.

In some examples, the energy device 160 is an energy-consuming device, an energy-producing device, and/or any other type of every device associated with energy. The energy-consuming device can be, for example, an air conditioner, a heater, a refrigerator, a light, a fan, an appliance (e.g., an oven, a blender, etc.), a control device (e.g., pump control, shade control, etc.), and/or any other type of device that consumes energy. As another example, the energy-producing device can be, for example, a renewable energy source (e.g., a solar panel, a wind generator, etc.), a generator (e.g., a diesel generator, a propane generator, etc.), grid power, an energy-storing device (e.g., a battery, a hydrogen cell, etc.), and/or any other type of device that produces and/or stores energy.

In other examples, the wireless controllers 110 communicate with each other via the wireless mesh network 170. Each wireless controller 110 can receive communications from other wireless controllers 110 and route the communication to the wireless gateway 130. For example, the wireless controller E 110e transmits energy data associated with the energy consuming device 160 to the wireless controller C 110c. The wireless controller C 110c determines the best route (e.g., shortest number of transmission hops, lowest latency time for the transmission, etc.) for the transmission of the energy data and transmits the energy data to the wireless controller D 110d. The wireless controller C 110c can, for example, receive availability data (e.g., shortest number of transmission hops, lowest latency time, electrical power, etc.) regarding the wireless mesh network 170. The wireless controller D 110d determines the best route for the transmission of the energy data and transmits the energy data to the wireless gateway 130. The wireless mesh network 170 can, for example, include a wireless repeater for forwarding and/or routing communication over the wireless mesh network 170. The wireless gateway 130 transmits the energy data to the management server 120.

In some examples, the wireless controllers 110 is configured for other types of wired and/or wireless networks. More generally, the energy management system 100 can include any number of wireless controllers 110, and each wireless controller 110 can individually manage any number of energy devices 160.

In other examples, the client module 150 includes a web-based interface utilized to manage the management server 120 and/or the wireless controllers 110 via the network 140. A user and/or an administrator can, for example, access the client module 150 utilizing a transmitting device (e.g., laptop computer with a web browser) and remotely control the system 100. The user and/or the administrator can remotely control the system 100 by directly communicating with the wireless controls 110 or by communicating with the management server 120. The client module 150 can control access via various granular levels of access utilizing a username/password and/or any other type of authentication/authorization mechanism. For example, the user utilizing the client module 150 via the transmitting device can monitor current energy consumption conditions and the wireless mesh network 170 status. The user can also view historical trending charts and analysis reports created by the management server 120. As another example, the user, depending on their access level, can modify the energy profile (e.g., modify temperature set points for the modes and the schedules). Although FIG. 1B illustrates the client module 150 separate from the management server 120, the client module 150 can be integrated into the management server 120.

In some examples, the energy data includes energy consumption data, environmental data, energy generation data, and/or any other type of data associated with building management (e.g., direction of windows on the building, prevailing wind, insulation type, oil tank level, propane tank level, alert information, etc.). The energy consumption data can include, for example, energy used by the energy device 160, energy saved by the energy device 160, further energy use by the energy device 160, proposed energy use by the energy device 160, cost of different types of energy, and/or any other type of data associated with the consumption of energy. The environmental data can include, for example, outside temperature, inside temperature, outside humidity, inside humidity, rainfall, sunlight coverage, environmental costs of different types of energy (e.g., cost of one kilowatt of wind power, greenhouse gas emissions for one kilowatt of coal power, etc.), and/or any other data associated with the environment. The energy generation data can include, for example, alternative energy generation level (e.g., solar power generation, wind power generation, etc.), grid power level, and/or any other type of data associated with energy generation.

Although FIG. 1B illustrates communication between the wireless mesh network and the management server via a wireless gateway and a network, the management server 120 can be, for example, connected to the wireless mesh network 170. For example, the management server 120 in the energy management system 100 for a residential house can be situated in the house and can be directly connected to a wireless mesh network 170 of wireless controllers 110 located in the house.

Although FIG. 1B illustrates a single wireless mesh network of wireless controllers 110, a single wireless gateway 170, and a single management server 120, the energy management system 100 can include any number of wireless controllers 110, management servers 120, wireless gateways 130, and/or wireless mesh networks 170 of wireless controllers 110. For example, an energy management system 110 servicing several office buildings includes a separate wireless mesh network of wireless controllers for each office building, a separate wireless gateway for each wireless mesh network, and a single management server managing all of the wireless controllers.

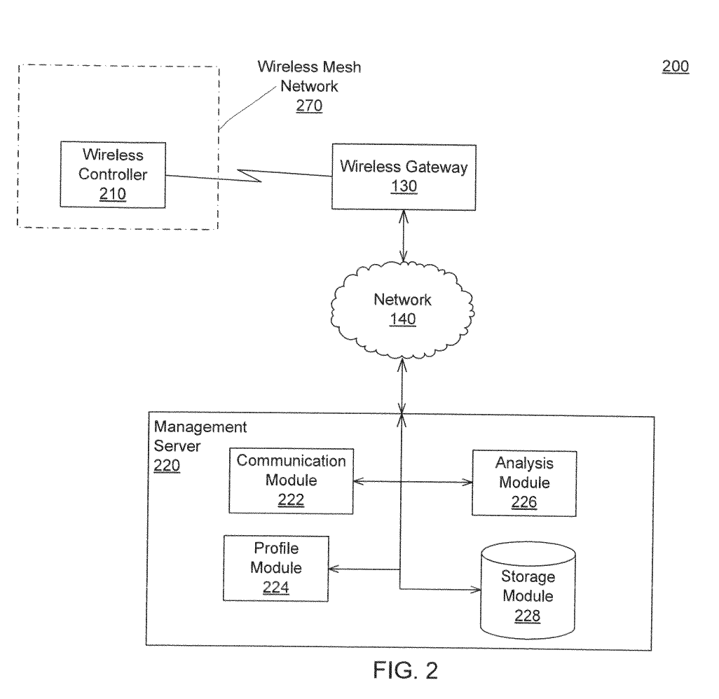

Referring to FIG. 2, an energy management system 200 includes a management server 220, a network 140, a wireless gateway 130, and a wireless controller 210 configured in a wireless mesh network 270. The management server 220 communicates via the network 140 to the wireless gateway 130. The management server 220 includes a communication module 222, a profile module 224, an analysis module 226, and a storage module 228. The communication module 222 monitors and receives energy data from the wireless controller 210 via the wireless gateway 130 and the network 140. The profile module 224 manages the energy profile and transmits part or all of the energy profile to the wireless controller 210 via the network 140 and the wireless gateway 130. The analysis module 226 analyzes the energy data received by the communication module 222 and creates modifications to the energy profile managed by the profile module 224. The storage module 228 stores the energy data, the modifications to the energy profile, and/or the energy profile.

The communication module 222 receives energy data from the wireless controller 210. Table 3 illustrates exemplary energy data for lighting of the office complex by the wireless controller 110c of FIG. 1B utilizing the energy profile illustrated in Table 1.

TABLE 3
Exemplary Energy Data for Lighting.

| Action | Time | Day | Mode | Time |
|---|---|---|---|---|
| Unoccupied | | Sunday | Unoccupied | |
| Motion | 7:03 am | Monday | Unoccupied | 57 minutes |
| Occupied | 8:00 am | Monday | Occupied | |
| Unoccupied | 5:01 pm | Monday | Unoccupied | |
| Motion | 6:50 am | Tuesday | Unoccupied | 70 minutes |
| Occupied | 8:00 am | Tuesday | Occupied | |
| Unoccupied | 5:01 pm | Tuesday | Unoccupied | |
| Motion | 7:13 am | Wednesday | Unoccupied | 47 minutes |
| Occupied | 8:00 am | Wednesday | Occupied | |
| Unoccupied | 5:01 pm | Wednesday | Unoccupied | |
| Motion | 7:02 am | Thursday | Unoccupied | 58 minutes |
| Occupied | 8:00 am | Thursday | Occupied | |
| Unoccupied | 5:01 pm | Thursday | Unoccupied | |
| Occupied | 8:00 am | Friday | Occupied | |
| Unoccupied | 5:01 pm | Friday | Unoccupied | |

Table 4 illustrates exemplary energy data for HVAC of the office complex by the wireless controller 110b of FIG. 1B utilizing the energy profile illustrated in Table 2.

TABLE 4
Exemplary Energy Data for HVAC.

| | | | | | Tem- |
|---|---|---|---|---|---|
| | | | | | per- |
| Action | Time | Day | Mode | Time | ature |
| Unoccupied | | Sunday | Unoccupied | | 65 |
| Ramp-Up | 7:00 am | Monday | Ramp-Up | | 65 |
| Override | 7:03 am | Monday | Ramp-Up | 57 minutes | 73 |
| Occupied | 8:00 am | Monday | Occupied | | 73 |
| Unoccupied | 5:01 pm | Monday | Unoccupied | | 65 |
| Override | 6:50 am | Tuesday | Unoccupied | 10 minutes | 73 |
| Ramp-Up | 7:00 am | Tuesday | Ramp-Up | | 70 |
| Override | 7:00 am | Tuesday | Ramp-Up | 60 minutes | 73 |
| Occupied | 8:00 am | Tuesday | Occupied | | 73 |
| Unoccupied | 5:01 pm | Tuesday | Unoccupied | | 65 |
| Ramp-Up | 7:00 am | Wednesday | Ramp-Up | | 70 |
| Override | 7:13 am | Wednesday | Ramp-Up | 47 minutes | 73 |
| Occupied | 8:00 am | Wednesday | Occupied | | 73 |
| Unoccupied | 5:01 pm | Wednesday | Unoccupied | | 65 |
| Ramp-Up | 7:00 am | Thursday | Ramp-Up | | 70 |
| Override | 7:02 am | Thursday | Ramp-Up | 58 minutes | 73 |
| Occupied | 8:00 am | Thursday | Occupied | | 73 |
| Unoccupied | 5:01 pm | Thursday | Unoccupied | | 65 |
| Ramp-Up | 7:00 am | Thursday | Ramp-Up | | 70 |
| Occupied | 8:00 am | Thursday | Occupied | | 73 |
| Override | 9:02 am | Thursday | Occupied | 129 minutes | 68 |
| Unoccupied | 5:01 pm | Thursday | Unoccupied | | 65 |

The communication module 222 can receive, for example, any type of energy data from energy devices and/or sensors. For example, the communication module 222 receives energy data associated with humidity of the office complex from one or more humidity sensors (not shown) in the office complex.

The analysis module 226 analyzes the energy data received by the communication module 222 (e.g., illustrated in Tables 3 and 4). The analysis module 226 creates modifications to the energy profile managed by the profile module 224. For example, the analysis module 226 analyzes the energy data in Table 3 and determines that on Monday, Tuesday, Wednesday, and Thursday, the lighting is controlled via the motion detector for approximately one hour before the Occupied mode is activated. Based on the energy data, the analysis module 226 creates modifications to the energy profile (in this example, modified start time for Occupied mode and modified end time for Unoccupied mode). The analysis module 226 communicates the modifications of the energy profile to the profile module 224.

The profile module 224 makes the modifications to the energy profile. As a further example, Table 5 illustrates the modified energy profile for the office lighting. The energy profile 224 transmits the modified office lighting energy profile to the wireless controller E 110e via the network 140 and the wireless gateway 130.

TABLE 5
Exemplary Modified Office Lighting Energy Profile.

| Mode | Start Time | End Time | Days | Lights | Time Delay |
|---|---|---|---|---|---|
| Occupied | 7:00 am | 5:00 pm | Weekdays | On | |
| Unoccupied | 5:01 pm | 6:59 am | Weekdays | Motion | 5 minutes |
| Unoccupied | | | Weekends | Off | |

The wireless controller E 110e manages the lights (i.e., the energy device 160) based on the modified office lighting energy profile stored by the wireless controller E 110e and activities and deactivates the lights according to the modified office lighting energy profile.

As a further example, the analysis module 226 analyzes the energy data in Table 4 and determines that on Monday, Tuesday, Wednesday, and Thursday, the HVAC system is turned on via an override button for approximately one hour before the Occupied mode is activated. Based on the energy data, the analysis module 226 creates modifications to the energy profile (in this example, modified start time for Occupied and Ramp-up mode and modified end time for Unoccupied mode). The analysis module 226 communicates the modifications of the energy profile to the profile module 224. The profile module 224 makes the modifications to the energy profile. As a further example, Table 6 illustrates the modified energy profile for the office HVAC. The energy profile 224 transmits the modified office HVAC energy profile to the wireless controller C 110d via the network 140 and the wireless gateway 130.

TABLE 6
Exemplary Modified Office HVAC Energy Profile.

| Mode | Start Time | End Time | Days | Temperature | Range |
|---|---|---|---|---|---|
| Ramp-Up | 6:00 am | 6:59 am | Weekdays | 70 | ±3 |
| Occupied | 7:00 am | 5:00 pm | Weekdays | 73 | ±3 |
| Unoccupied | 5:01 pm | 5:59 am | Weekdays | 65 | ±3 |
| Unoccupied | | | Weekend | 65 | ±3 |

In some examples, the analysis module 226 accesses energy data (e.g., current energy consumption data, past energy consumption data, environmental data, etc.) stored on the storage module 228 to create charts and/or reports regarding past, present, and/or future energy use for the system 200. The charts and/or reports can include, for example, a future energy savings chart/report (e.g., how much will be saved by the energy management system 200, how much can be saved by switching from a HVAC unit to another HVAC unit, etc.), a present energy chart/report (e.g., present use of alternative energy generation, present energy use of lights, etc.), a past energy chart/report (e.g., past use of alternative energy generation, past energy use of HVAC units, past indoor and outdoor temperatures, etc.) and/or any other type of chart/report associated with the energy management system 200 (e.g., use of energy by a type of energy device at one building compares to the use of energy of the same energy device at other buildings, energy devices operating at or below optimal efficiency, etc.).

For example, the analysis module 226 creates a energy report for the current inputted by the HVAC unit versus the average temperature outside of the building as recorded by a temperature sensor over the course of the past ten years. As another example, the analysis module 226 creates a time chart for the time between when the Occupied mode is activated until when individual rooms in a zone (e.g., all of the classrooms in a building) reach the set temperature. The time chart can be utilized by the analysis module 226 to modify the energy profile and/or can be utilized by the administrator to determine if the energy unit (e.g., HVAC unit) is underperforming, requires maintenance, and/or if any other issues exist for the rooms. As another example, the analysis module 226 creates a energy savings report based on past indoor and outdoor temperatures. The energy savings report can include, for example, the energy saved by the energy management system 200 (e.g., 15% of hearing energy was saved due to the energy management system 200 during the last two months; 25% of cooling energy was saved last quarter by optimized temperature ranges, etc.).

As another example, the analysis module 226 is configured to detect sudden decreases in temperature in a room (e.g., five degrees within ten minutes, ten degrees within twenty minutes, etc.). When sudden decreases in temperature in a room are detected, the analysis module 226 can alert the administrator and/or security personal since the sudden decrease in temperature may indicate a security event (e.g., open window or door).

As a further example, the analysis module 226 evaluates override requests to determine if the energy profile of a room is not meeting the user demands. For example, if the user is constantly overriding the energy profile every morning to decrease the temperature, then the energy profile could be adjusted to fit the user's desired temperature. However, if the user's desired temperature is below the minimum threshold (e.g., 68 degrees, 78 degrees, etc.) set by building management, then the analysis module 226 will not modify the energy profile below the minimum threshold set by the building management. In other embodiments, the modification of the energy profile based on the user's desired temperature needs approval by authorized personnel.

In other examples, the storage module 228 stores the energy data, the modifications to the energy profile, and/or the energy profile utilizing a database. For example, the storage module 228 stores the energy data, the modification to the energy profile, and/or the energy profile in a secured SQL database. The database can be, for example, accessed by the client module 150 and/or the management server 220. In other embodiments, the storage module 228 can be located remotely from the management server 220.

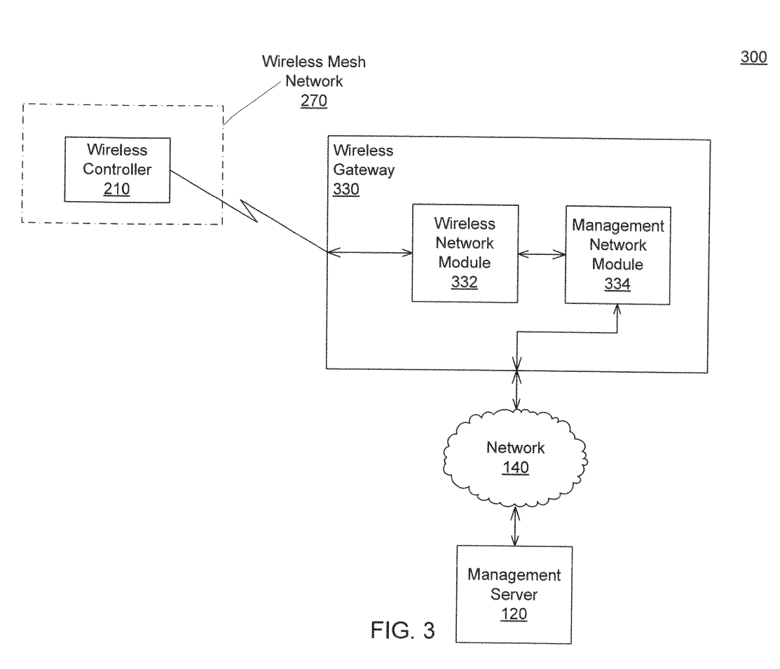

Referring to FIG. 3, an energy management system 300 includes the management server 120, the network 140, a wireless gateway 330, and the wireless controller 210 in the wireless mesh network 270. The wireless gateway 330 provides for communication between the network 140 and the wireless mesh network 270 (e.g., protocol conversion, communication packet forwarding and/or routing, etc.). The wireless gateway 330 includes a wireless network module 332 and a management network module 334.

The management server 120 transmits one or more parts of an energy profile via the network 140 to the management network module 332. The management network module 332 processes the one or more parts of the energy profile (e.g., stores the parts, identifies the recipient of the parts, etc.) and communicates the parts of the energy profile to the wireless network module 334 which transmits the parts of the energy profile to the wireless controllers 110. The wireless network module 334 receives energy data transmitted by the wireless controllers 210 via the wireless mesh network 170. The wireless network module 334 processes the energy data (e.g., stores the energy data, identifies the recipient of the energy data, etc.) and communicates the energy data to the management network module 332. The management network module 332 transmits the energy data via the network 140 to the management server 120.

In some examples, the wireless gateway 330 stores the one or more parts of the energy profile and/or the energy data in a storage module (not shown). The wireless gateway 330 can be, for example, utilized as the centralized storage of the energy profile and/or the energy data.

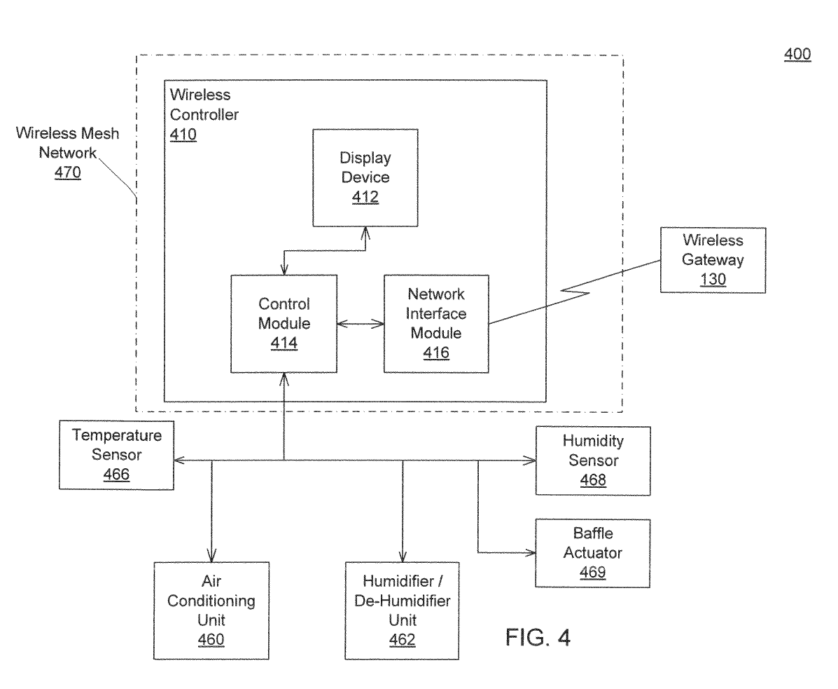

Referring to FIG. 4, an energy management system 400 includes a wireless controller 410, a wireless mesh network 470, the wireless gateway 130, an air conditioning unit 460, a humidifier/de-humidifier unit 462, a temperature sensor 466, a humidity sensor 468, and a baffle actuator 469. In some embodiments, the temperature sensor 466 and the humidity sensor 468 can be included in the wireless controller 410. In other embodiments, the baffle actuator 469 can be included in the wireless controller 410. The wireless controller 410 includes a display module 412, a control module 414, and a network interface module 416. The wireless gateway 130 communicates with the wireless controller 410 via the wireless mesh network 470.

The air conditioning unit 460, the humidifier/de-humidifier unit 462, the temperature sensor 466, and the humidity sensor 468 communicate with the control module 414. The control module 414 receives the energy data from the air conditioner unit 460 and the humidifier/de-humidifier unit 462 and transmits the energy data utilizing the network interface 416 via the wireless mesh network 470 to the wireless gateway 130. The control module 414 also receives temperature data from the temperature sensor 466 and humidity data from the humidity sensor 468 and transmits the temperature data and the humidity data utilizing the network interface 416 via wireless mesh network 470 to the wireless gateway 130.

The network interface module 416 receives part or all of an energy profile via the wireless mesh network 470 from the wireless gateway 130. The part or all of the energy profile is communicated from the network interface module 416 to the control module 414. The control module 414 manages the air conditioner unit 460 and the humidifier/de-humidifier unit 462 based on part or all of the energy profile and/or on data received from temperature sensor 466 and humidity sensor 468. The display device 412 provides visual (e.g., flashing lights, color, intensities, text, graphics, etc.), audio (e.g., bells, tones, tunes, voice, etc.), and/or tactile communication to users of the wireless controller 410. In other embodiments, the display device 412 provides advertisements, local information (e.g., town meetings, baseball game information, etc.), national information, and/or any other type of information communicated by a visual, audio, and/or tactile communication.

The control module 414 manages the baffle actuator 469. The baffle actuator 469 can actuate and/or deactuate a baffle in the energy management system 400. In other embodiments, the control module 414 manages one or more wireless actuators (not shown). The wireless actuators can, for example, actuate and/or deactuate the energy devices (e.g., ventilation devices, fans, baffles, gates, etc.).

In some examples, the control module 414 determines the cost of utilizing the air conditioning unit 460 based on the energy costs of the energy source (e.g., line power). The control module 414 can utilize the display device 412 to communicate the energy costs to the user. For example, the user requests the control module 414 to decrease the temperature from 68° to 66°. The control module 414 further queries the user to ensure that the user desires to decrease the temperature based on the energy costs (e.g., ten dollars per day, etc.) and/or environmental costs (e.g., four pounds of carbon dioxide produced, etc.). In other words, the control module 414 requires the user to confirm the request for the energy device after communicating the energy costs and/or environmental costs of the user's request.

In other examples, the temperature sensor 466 and/or the humidity sensor 468 are wireless and configured to send data to wireless controller 414 and/or the management server 120 via the wireless mesh network 470. The temperature sensor 466 and/or the humidity sensor 468 can be utilized as the control for the air conditioning unit 460 and/or the humidifier/de-humidifier unit 462. In other examples, the temperature sensor 466 and/or the humidity sensor 468 are utilized to record and/or analyze data regarding the building and/or the environment. For example, the temperature sensor 466 is placed outside of the building to determine the outside temperature so that the energy profile can be modified based on the weather. The sensor 466 or 468 can be battery-powered and configured to minimize power usage. An advantage to utilizing self-sufficient sensors is that the sensors can be easily placed by users/administrators to monitor changing conditions (e.g., extra temperature sensor in computer sever room during a HVAC unit maintenance period, heat sensor in office suite while the office suite is under renovations).

In some examples, the wireless controller 410 has occasional and/or sporadic communicate with the management server 120 via the wireless mesh network 470. The control module 414 can advantageously execute the parts of the energy profile associated with the wireless controller 410 and/or can modify the parts of the energy profile associated with the wireless controller 410 which enables the wireless controller 410 to operate autonomously from the management server 120 and/or other wireless controllers 110.

In other examples, the wireless controller 410 can send alerts directly to administration and/or users based on the parts of the energy profile. For example, when the temperature drops below the alert level (in this example, temperature is 65 degrees and the alert level is 70 degrees), then the wireless controller 410 transmits an alert to the administrator's pager (not shown) via the wireless mesh network 470.

In some examples, the wireless controller 410 can be utilized as a wireless mesh network repeater. In other words, the wireless controller 410 can be utilized to extend the range of the wireless mesh network 470 and allow for communication with wireless controllers 110 throughout a building and/or campus.

Although FIG. 4 illustrates the temperature sensor 466 and the humidity sensor 468, the energy management system 400 can include any type of sensor and/or alarm. The sensor can include a flow meter (e.g., water meter, gas meter, etc.), a power meter, a current meter, a battery meter, a pulse meter (e.g., network pulse, a human/animal pulse, etc.), a input/output node (e.g., monitor analog input/output, monitor digital input/output, etc.), a light sensor, a motion detector, a proximity sensor, a pressure sensor, a carbon dioxide sensor, a carbon monoxide sensor, a heat sensor, a network sensor, and/or any other type of sensor. The sensor can measure the environmental level of the particles of the materials and/or gases. The alarm can include an audible alarm, a flashing alarm, an automated telephone alert, an email alert, and/or any other type of alarm.

For example, the energy management system 400 can include smoke sensors throughout an office complex which communicate with the wireless controller for a fan for the office complex. As part of the fire alert protocol in the energy profile, the wireless controller 410 activities the fan at high speed when the smoke sensor detects smoke in a stairwell of the office complex. However, as part of the fire alert protocol in the energy profile, the wireless controller 410 activities the fan at low speed when the smoke sensor detects smoke in a bathroom of the office complex. In both cases of smoke detection, the energy management system 400 alerts an administration via the alert mechanisms (in this example, audible alarm, flashing alarm, and automated telephone alert).

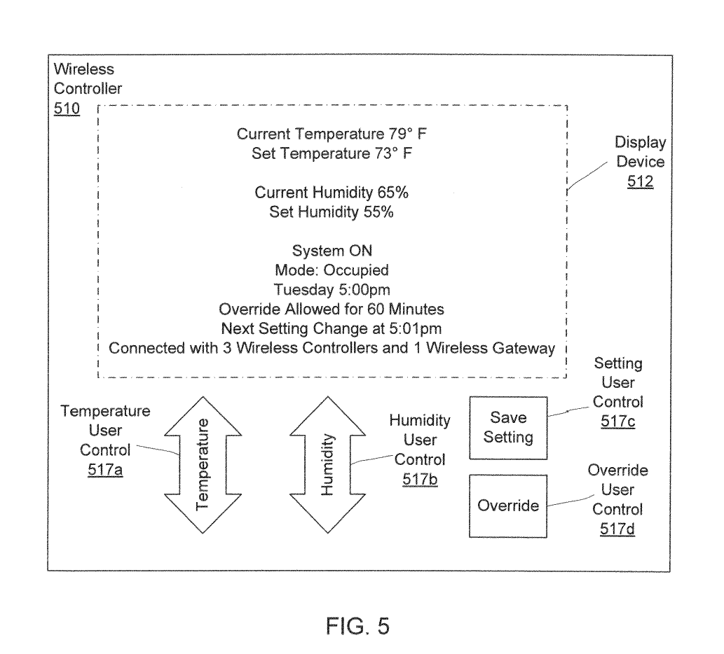

FIG. 5 shows an example of a wireless controller 510 providing thermostat functions. The wireless controller 510 includes a display device 512, a temperature user control 517a, a humidity user control 517b, a setting user control 517c, and an override user control 517d. A user can adjust the temperature and humidity levels of the room serviced by wireless controller 510 via the temperature user control 517a and the humidity user control 517b, respectively, within the limits of all or part of the energy profile. The user can override the settings as defined by the energy profile by utilizing the override user control 517d. The override user control 517d can be used to temporarily (e.g., sixty minutes, one day, etc.) override the mode settings. The user can also save the updated setting and/or request that the updated setting be saved by utilizing the setting user control 517c. An advantage of utilizing the user controls is that the energy management system 100 is easy to use and is similar to existing user controls for energy systems and thus more efficient to use and learn by the user (i.e., better user compliance for energy management). It should be noted that existing thermostat devices can be utilized in conjunction with the wireless controller 510 to reduce the cost of retrofitting the energy management system 500.

For example, the wireless controller 510 is utilizing the HVAC energy profile as illustrated in Table 2 to manage the operation of a HVAC unit. As illustrated by the display device 512, the set temperature for the controller based on the Occupied mode is 73 degrees. However the current temperature is 79 degrees. As such, the HVAC system is currently activated (i.e., ON). As illustrated by the display device 512, the next mode change is at 5:01 pm (in this example, the mode change is from Occupied to Unoccupied). The user can override the Occupied mode setting by adjusting the temperature utilizing the temperature user control 517a. As illustrated in Table 3, at 7:00 am on Tuesday morning, the user overrode the Ramp-Up mode setting and increased the temperature from 70 degrees to 73 degrees. In addition, the redundant connection oriented design of the wireless mesh network 170 is illustrated in the display device 512 via the wireless connection with three other wireless controllers and one wireless gateway (e.g., wireless controller D 110d of FIG. 1B).

In some examples, the wireless controller 510 can display other types of information. For example, the wireless controller 510 can display time, weather forecasts, announcements (e.g., school announcements, business announcements), advertisements, and/or any other type of information that can be displayed to a building, a zone, and/or any other delineation of the wireless controllers 110. As another example, the wireless controller 510 can be utilized to display the time and receive time updates from a centralized time server (not shown).

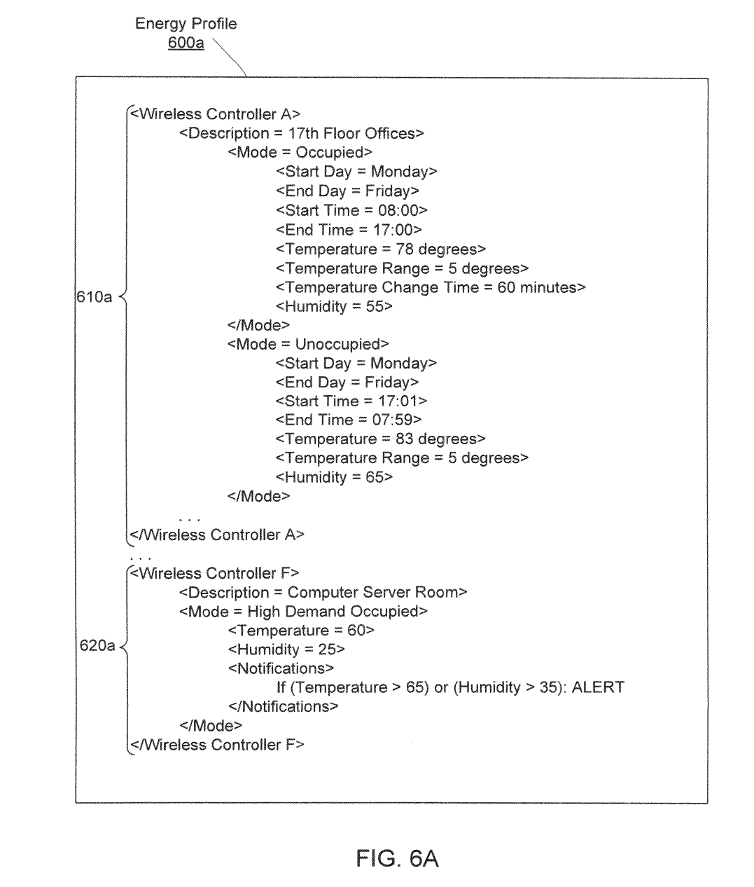

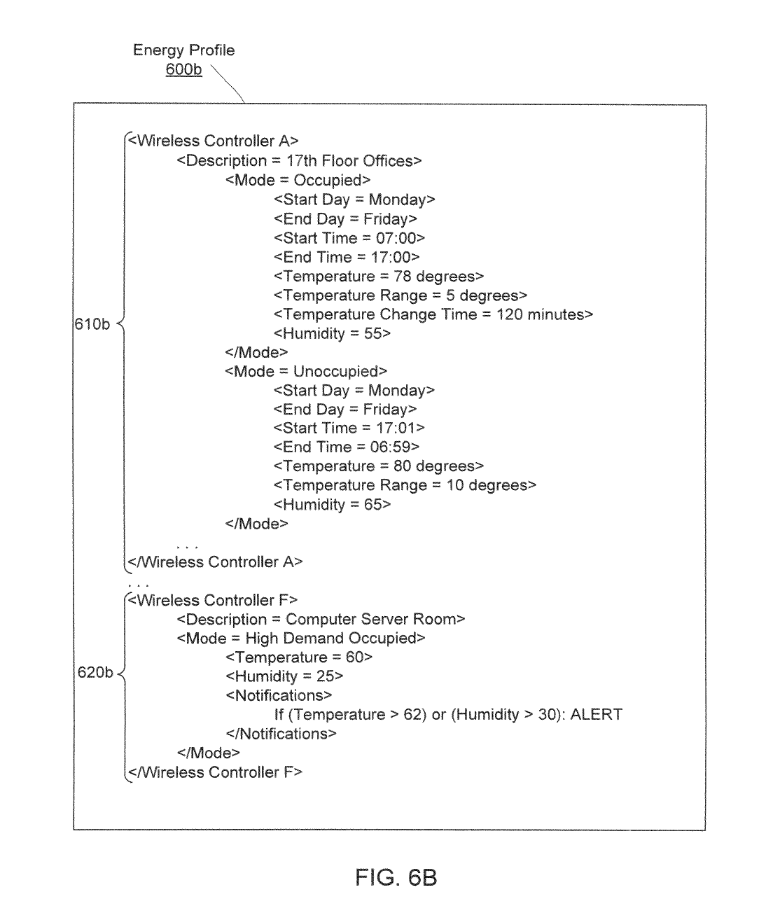

FIG. 6A illustrates an example of parts of an energy profile 600a. The energy profile 600a includes two parts 610a and 620a. Part 610a includes parameters governing the autonomous behavior of a wireless controller servicing several offices. Because the offices are generally vacant during non-business hours, part 610a includes one set of parameters during the work day (in this example, 8:00 am to 5:00 pm) and another set of parameters at night (in this example, 5:01 pm to 7:59 am) to conserve energy. Part 620a includes parameters governing the autonomous behavior of a wireless controller servicing a computer server room. Because computer server rooms require careful constant temperature and humidity management, part 620a includes stricter parameters than part 610a. Part 620a also specifies that an administrator is alerted if environmental conditions within the computer server room rise above specified thresholds so that the user can respond appropriately.

FIG. 6B shows another example of the energy profile 600b. The energy profile 600b is a modified version of the energy profile 600a of FIG. 6A. The analysis module 226 of FIG. 2 determined the modifications for the energy profile 600a and communicated the modifications to the profile module 224. The profile module 224 modified the energy profile 600a to the modified energy profile 600b based on energy data associated with the energy device (in this example, HVAC unit), weather parameters (e.g., average temperature, average humidity, average rainfall, average sunshine, etc.) and/or preferences by the building management (e.g., maximum temperature, minimum temperature, etc.).

The profile module 224 modifies the part 610a of the energy profile 600a associated with the wireless controller A to form the part 610b of the energy profile 600b. The modifications to the Occupied mode include changing the start time and the temperature change time. These modifications to the Occupied time were made by the analysis module 226 in response to changes in the weather parameters (in this example, daylight savings time). Accordingly, the Unoccupied mode was similarly modified to correctly correlate the start and end times for the seventeenth floor offices.

Additionally, the profile module 224 modifies the part 620a of the energy profile 600a associated with the wireless controller F to form the part 620b of the energy profile 600b. The modifications to the High Demand Occupied mode include changing the notification parameters. These modifications to the High Demand Occupied mode were made by the analysis module 226 in response to changes to the preferences by the building management. In other words, the building management needed earlier notifications when the computer server room was not near the set temperature and humidity settings (in this example, 60 degrees and 25% humidity).

The energy profile 600a or 600b can include any number of parts. In some examples, the management server 120 of FIG. 1B can manage multiple energy profiles. For example, an energy management system 100 servicing several schools in different geographic locations can have one management server 120 managing a separate energy profile for each school. As another example, the management server 120 can manage a single energy profile for all of the elementary schools in a school district since all of the elementary schools have similar energy needs (e.g., start time, end time, temperature, override capabilities, etc.).

FIGS. 6A and 6B illustrate that different parts of the same building can have different settings and/or modes. In other words, the same building can have different zones for temperature, lights, sensors, and/or other type of energy device managed by the energy management system 100. For example, Table 7 illustrate the use of different zones and modes for buildings.

TABLE 7
Exemplary Classroom Energy Profile.

| Mode | Zone | Setting | Day | Time |
|---|---|---|---|---|
| Occupied | All Classrooms | Lights - On | Weekdays | 8:00 to 17:00 |
| Unoccupied | All Classrooms | Lights - Off | Weekdays | 17:01 to 7:59 |
| Occupied | East | HVAC - 73 | Weekdays | 7:00 to 17:00 |
| | Classrooms | | | |
| Unoccupied | East | HVAC - 68 | Weekdays | 17:01 to 6:59 |
| | Classrooms | | | |
| Occupied | West | HVAC - 76 | Weekdays | 8:00 to 17:00 |
| | Classrooms | | | |
| Unoccupied | East | HVAC - 70 | Weekdays | 17:01 to 7:59 |
| | Classrooms | | | |

In some examples, the energy profile 600a or 600b is created and/or modified utilizing a scheduling structure utilizing a time period (e.g., fifteen minute increments, one hour increments, etc.). The scheduling structure can be hierarchical with a plurality of structures (e.g., default schedule, vacation schedule, special event schedule, etc.). The scheduling structure can include a default schedule with normal business hours (e.g., Monday through Friday from 8:00 am to 5:00 pm, seven days a week from 10:00 am to 10:00 pm, etc.). An advantage to the default schedule is that the default schedule enables uniform and generic modifications to be made to the energy profile. For example, the start time for normal business hours is modified from 10:00 am to 11:00 am.

It should be understood that various rooms (e.g., computer rooms) can retain their own energy profile regardless of the vacation schedule. The scheduling structure can include, for example, a vacation schedule that can apply to all zones (e.g., rooms) of a building or set of buildings and/or to a set of zones (e.g., West Classrooms) of a building or set of buildings. For example, a building/school holiday is Monday, July 4. The holiday, July 4, is scheduled to set All Classrooms to Unoccupied mode for Monday, July 4. As another example, the renters in the offices on the 23rd floor have a vacation scheduled for Friday, December 24. However, the renters in the office on the 22nd floor do not have a vacation schedule for Friday, December 24. As such, the holiday, December 24, is scheduled for the zone of offices on the 23rd floor and not the zone of offices on the 22nd floor.

The scheduling structure can include, for examples, a special events schedule that can apply to all zones of a building or set of buildings and/or to a set of zones of a building or set of buildings. For examples, the special events schedule can be utilized to override the default schedule and/or the vacation schedule. For example, the entire office complex is scheduled to be in Unoccupied mode on Saturday, December 25, since Saturday is outside of the normal business hours based on the default schedule and since December 25 is a holiday based on the vacation schedule. However, the top floor, 47th floor of the office complex is scheduled to have a party on Saturday, December 25. As such, a special event is scheduled for the 47th floor for Saturday, December 25. The special event can be utilized to override the default schedule and the vacation schedule.

In other examples, the energy profile utilizes different operational modes to optimize the energy use under certain conditions. For example, as illustrated in Table 7 above, the classrooms have an Occupied mode and an Unoccupied mode. When the lights are in Occupied mode, then the lights are on and when the lights are in Unoccupied mode, then the lights are off. The automatic and uniform application of the mode utilizing the energy profile advantageously enables the optimally regulation of energy consumption under particular conditions in order to minimize waist. Table 8 illustrates different operational modes in the context of a HVAC unit. Although Table 8 illustrates the different operational modes in the context of a HVAC unit, the different operational modes can be utilized for any type of energy device.

TABLE 8
Exemplary Operational Modes

| Mode | Description | Temperature | Range | Trigger |
|---|---|---|---|---|
| Occupied | Full | Energy profile | Set per comfort | Schedule, occupancy |
| | occupancy | control or local | range (e.g., ±3 | sensors or exit of |
| | | thermostat | degrees) | Override mode |
| Unoccupied | Empty | Local thermostat | Disabled | Schedule or |
| | | disabled | | occupancy sensors |
| Override | Manual | Local thermostat | Wider comfort | Override button |
| | control | within energy | range (e.g., ±5 | |
| | | profile | degrees) | |
| Maintenance | Manual | Local thermostat | Maintenance | Override button |
| | control | with time limit | control range | |
| | | | (e.g., ±10 | |
| | | | degrees) | |
| Demand | Full | Energy profile | Disabled | Energy requirements |
| Response | occupancy | control | | from the electrical |
| | during peak | | | grid |
| | energy | | | |
| | consumption | | | |
| Optimal | Energy | Energy profile | Depends on | Energy source |
| Generation | source | control | generation | availability |
| Source | availability | | source | |
| Transition | HVAC | Energy profile | Not applicable | Schedule, outside |
| | transition | control and/or | | temperature, weather |
| | from heating | other factors | | forecast, and/or |
| | to cooling, | | | statistical data |
| | etc. | | | |

The operational modes can be utilized for any type of energy device to allow for the operation of the energy device. For example, in the demand response mode, the energy profile for the lighting can be configured to turn off half of the lighting in a grocery store to conserve energy consumption. As another example, in optimal generation mode, the wireless controller controlling the energy producing devices (e.g., electrical grid power, wind generator, etc.) changes the input power to the system 100 based on the current sensor data that a cheaper energy producing device is available (in this example, change the energy producing device from electrical grid power to the wind generator).

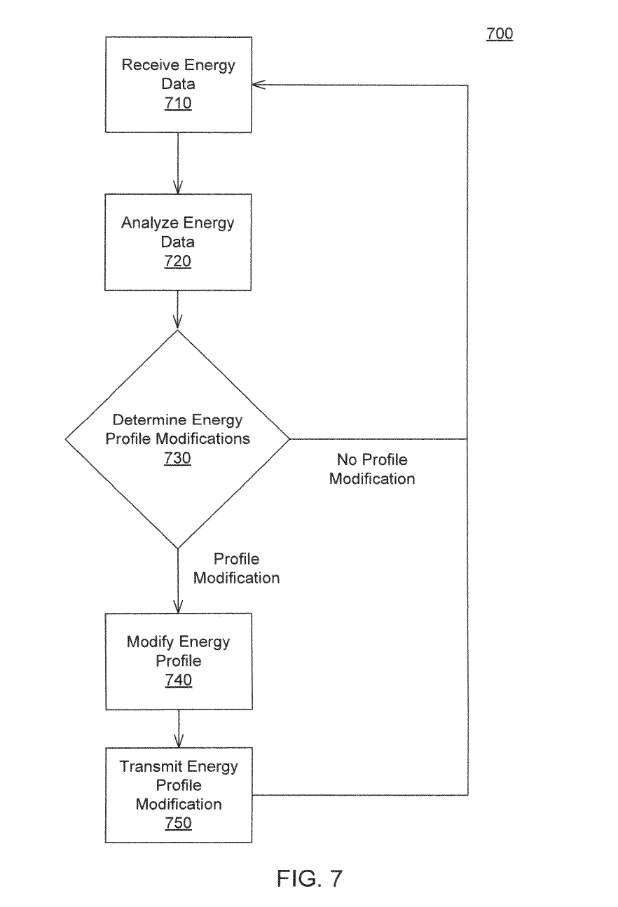

FIG. 7 is a flowchart 700 illustrating management of wireless controllers 210 by a management server 220 utilizing an energy profile and energy data as illustrated by FIG. 2. The communication module 222 of the management server 220 receives (710) energy data from the wireless controller 210 via the wireless mesh network 270, the wireless gateway 130, and the network 140. The analysis module 226 analyzes (720) the energy data and determines (730) if any modifications are needed for the energy profile. If energy profile modifications are not needed, then the communication module 222 continues receiving (710) energy data from the wireless controller 210.

If energy profile modifications are needed, then the analysis module 226 communicates the modifications to the profile module 224. The profile module 224 modifies (740) the energy profile based on the modifications to the energy profile and/or other parameters (e.g., weather information, user preferences, building preferences, etc.). The profile module 224 transmits (750) the modified energy profile to the wireless controller 210 and the communication module 222 continues to receive (710) energy data.

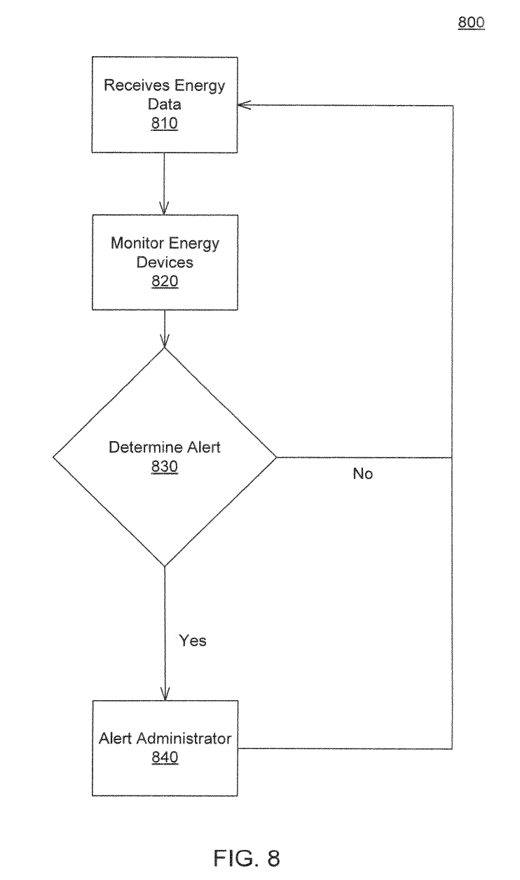

FIG. 8 is a flowchart 800 illustrating monitoring of wireless controllers 110 and associated energy devices by a management server 120 as illustrated by FIG. 1B. The management server 120 receives (810) energy data from one or more wireless controllers 110. The management server 120 monitors (820) the energy devices (e.g., 160) utilizing the energy data. If the management server 120 determined (830) that any alerts are needed, then the management server 120 alerts (840) an administrator and continues to receive (810) energy data. If the management server 120 determines (830) that no alerts are needed, then the management server 120 continues to receive (810) energy data.

For example, the wireless controller F 110f is managing a HVAC unit for the Computer Server Room. The wireless controller F is utilizing the part 620b of the energy profile 600b. The notification as illustrated in the part 620b is that an alert occurs if the temperature is greater than 62 degrees or if the humidity is greater than 30%. The management module 120 receives (810) energy data from the wireless controller F 110f. The management module 120 monitors (820) the HVAC unit utilizing the energy data. In this example, the energy data is 4:32 pm on Tuesday; temperature=65; humidity=29. The management module 120 determines (830) that an alert is needed based on the energy data (in this example, temperature is greater than 62 degrees) and alerts (840) per the appropriate alert mechanism (in this example, flashing light on the administrator's computer counsel and an automated email to the computer administrator).

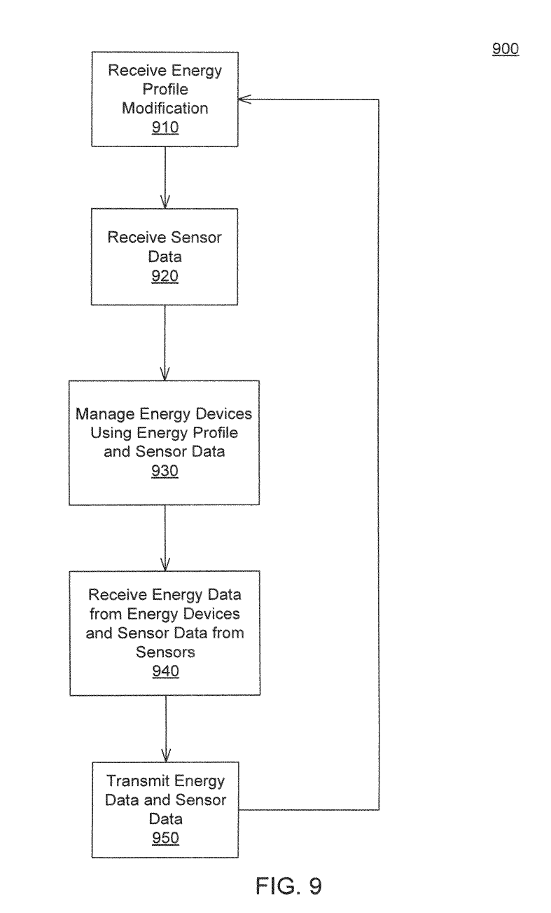

FIG. 9 is a flowchart 900 illustrating management and monitoring of energy devices 460 and 462 by a wireless controller 410 utilizing an energy profile and sensor data as illustrated by FIG. 4. The network interface module 416 receives (910) energy profile modifications from the management server 120 of FIG. 1B and communicates the energy profile modifications to the control module 414. The control module 414 receives (920) sensor data from the temperature sensor 466 and the humidity sensor 468. The control module 414 manages (930) the energy devices (in this example, the air conditioning unit 460 and the humidifier/de-humidifier unit 462) based on the energy profile and/or the sensor data. The control module 414 receives (940) energy data from the energy devices 460 and 462 and sensor data from the sensors 466 and 468 and transmits (950) the energy data and the sensor data to the management sever 120 via the network interface module 416. The network interface module 416 continues to receive (910) energy profile modifications from the management server 120.

Although the management server 120 of FIG. 1B and the client module 150 is described as analyzing the energy data and/or creating the reports regarding the energy data, each wireless controller 110 can analyze the energy data and/or create reports regarding the energy data. For example, the wireless controller F 110f can analyze energy consumption for HVAC unit associated with the computer server room and display on the display device 512 a report that the HVAC unit has maintained the set temperature within the temperature range for a percentage of the time (in this example, HVAC unit performance 98%).

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be communication provided to the user in any form of sensory feedback (e.g., visual feedback, auditory feedback, or tactile feedback). Input from the user can, for example, be received in any form, including text, acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network).

The system can include clients and servers. A client and a server are generally remote from each other and typically interact through a communication network. The relationship of client and server arises by virtue of computer programs running on the respective computers and having a client-server relationship to each other.

Examples of communication networks include wired networks, wireless networks, packet-based networks, and/or circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A management server, comprising:
a communication module for receiving energy data from one or more wireless controllers and one or more energy devices associated with the wireless controllers;
an analysis module for analyzing the energy data to create modifications for one or more parts of an energy profile; and
a profile module for managing the one or more parts of the energy profile and modifying the one or more parts of the energy profile based on the modifications, wherein the communication module transmits the modified one or more parts of the energy profile to the wireless controllers.

2. The management server of claim 1, further comprising a client module for remote management of the management server.

3. The management server of claim 1, further comprising a storage module for storing the energy data, the modifications for one or more parts of the energy profile, the one or more parts of the energy profile, or any combination thereof.

4. The management server of claim 1, wherein the analysis module further creates a report based on the energy data.

5. The management server of claim 1, wherein the analysis module further determines an alert based on the energy data.

6. A management server, comprising:
means for receiving energy data from one or more wireless controllers and one or more energy devices associated with the wireless controllers;
means for analyzing the energy data to create modifications for one or more parts of an energy profile;
means for managing the one or more parts of the energy profile; and
means for modifying the one or more parts of the energy profile based on the modifications, wherein the communication module transmits the modified one or more parts of the energy profile to the wireless controllers.

7. A method for energy management, the method comprising:
receiving energy data from one or more wireless controllers and one or more energy devices associated with the wireless controllers;
analyzing the energy data to create modifications for one or more parts of an energy profile;
modifying the one or more parts of the energy profile based on the modifications; and
transmitting the modified one or more parts of the energy profile to the wireless controllers.

8. The method of claim 7, wherein the energy profile comprising one or more operational modes.

9. The method of claim 8, wherein the energy profile includes a schedule specifying the operational mode utilized in a given timeframe.

10. The method of claim 9, wherein the schedule includes a hierarchy of one or more sub-schedules.

11. The method of claim 7, wherein the schedule includes at least one of a default schedule, a vacation schedule, or a special event schedule.

12. The method of claim 7, further comprising remotely managing, by a client module, the management server.

13. The method of claim 7, further comprising storing, by a storage module, the energy data, the modifications for one or more parts of the energy profile, the one or more parts of the energy profile, or any combination thereof.

14. The method of claim 7, further comprising creating, by the analysis module, a report based on the energy data.

15. The method of claim 7, further comprising determining, by the analysis module, an alert based on the energy data.
